(19) United States
(12) Patent Application Publication
(10) Pub. No.: US 2016/0250570 A1
(43) Pub. Date: Sep. 1, 2016

(54) FEED CONDITIONING AUTOMATION

(71) Applicants: Jerry HUNT, Murray, UT (US); FLSmidth A/S, Valby (DK)

(72) Inventor: Jerry Hunt, Murray, UT (US)

(73) Assignee: FLSmidth A/S, Valby (DK)

(21) Appl. No.: 15/028,697

(22) PCT Filed: Oct. 30, 2014
(86) PCT No.: PCT/US14/63072

§ 371 Date: Apr. 11, 2016

Related U.S. Application Data
(60) Provisional application No. 61/897,569, filed on Oct. 30, 2013.
(60) Provisional application No. 61/925,592, filed on Jan. 9, 2014.

(51) Int. Cl. B01D 21/32; B01D 21/30; B01D 33/04; B01D 21/01

(52) U.S. Cl. CPC B01D 21/32; B01D 21/01; B01D 21/302; B01D 33/04

(57) ABSTRACT

A system for dewatering tailings is disclosed. The system comprises a thickener having a settling tank; a mixing chamber in communication with the thickener for receiving an effluent from the settling tank, and a flocculating agent tank; wherein a valve is provided for selectively limiting a flow of flocculating agent from the flocculating agent tank to the mixing chamber. An optical detector is provided in optical communication with an effluent from the mixing chamber, and an automation controller is provided in communication with the detector and the valve. In use, the automation controller receives data from the detector and provides a control signal to the valve based on the data from the detector.

### CROSS-REFERENCE TO RELATED APPLICATIONS

This application claims the benefit of international application no. PCT/US2014/063072 filed Oct. 30, 2014, U.S. Provisional Patent Application No. 61/897,569 filed on Oct. 30, 2013 and U.S. Provisional Patent Application No. 61/925,592 filed on Jan. 9, 2014.

### TECHNICAL FIELD

This disclosure relates generally to systems and methods for automating feed conditioning. Specifically, this disclosure relates to automation of feed conditioning for a filter press.

### BRIEF DESCRIPTION OF THE DRAWINGS

Non-Limiting and non-exhaustive embodiments of the disclosure are described, including various embodiments of the disclosure, with reference to the figures, in which:

FIG. 1 illustrates a flow diagram of one embodiment of a system for dewatering process tailings.

FIG. 2 illustrates a flow diagram of one embodiment of a system for feed conditioning automation of a tailings dewatering process.

FIG. 3 illustrates a flow diagram of another embodiment of a system for feed conditioning automation of a tailings dewatering process.

### DETAILED DESCRIPTION

In many industrial and other processes, separation of materials is needed for improving an end product, proper disposal, reuse of a material, or the like. Such separation may include a separation of a solid-phase material from a liquid-phase, where the solid-phase material and the liquid-phase material are in slurry form. Often filters such as belt filters, filter presses, vacuum filters, and the like may be used as part of the separation process. To enhance the filtering step, a slurry may undergo a thickening step, which may concentrate the solids such that a lower-water concentration of solids is applied to the filter. To further enhance the filtering step, solids in the slurry effluent from the thickener may be flocculated or coagulated using a flocculating or coagulating agent before being applied to the filter.

Flocculating or coagulating agents (as used herein, unless specifically indicated otherwise, both are referred to as “flocculating agent”, and “flocculation” includes “coagulation”) may be tailored to the specific solids and/or concentration to be applied to the filter. That is, the specific agent used, the amount used, and the conditions of flocculation may be specific to the solids and/or liquids to be separated from the slurry.

For example, tailings may be produced in the coal mining and processing industry. Such tailings may be in the form of a slurry that includes the fine coal tailings, clays, ash, minerals, water, and the like. Such slurry may be mostly water. In one embodiment, the slurry may include from around 50% to around 99% water, and more specifically from around 60% to around 80% water. Such slurry may previously have been simply discarded in tailings impoundment. However, at such low tailings concentrations, the area for tailings impoundment would be exhausted at a higher rate than if the concentration of tailings were higher. Furthermore, in such prior processes, excess amounts of water were impounded that may have otherwise been used in the coal mining or processing processes.

The present disclosure provides for separation of solids in a slurry by thickening, flocculation, and filtering by automating the addition of flocculation agent to the slurry before filtering thereof.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. In particular, “an embodiment” may be a system, an article of manufacture, a method, or a product of a process.

The phrases “connected to” and “in communication with” refer to any form of interaction between two or more components, including mechanical, electrical, magnetic, and electromagnetic interaction. Two components may be connected to each other even though they are not in direct contact with each other and even though there may be intermediary devices between the two components.

In some cases, well-known features, structures, or operations are not shown or described in detail. Furthermore, the described features, structures, or operations may be combined in any suitable manner in one or more embodiments. The components of the embodiments, as generally described and illustrated in the figures herein, could be arranged and designed in a wide variety of different configurations. In addition, the steps of the described methods do not necessarily need to be executed in any specific order, or even sequentially, nor need the steps be executed only once, unless otherwise specified.

The embodiments of the disclosure are best understood by reference to the drawings, wherein like parts are designated by like numerals throughout. In the following description, numerous details are provided to give a thorough understanding of various embodiments; however, the embodiments disclosed herein can be practiced without one or more of the specific details, or with other methods, components, materials, and the like. In other instances, well-known structures, materials, or operations are not shown or described in detail to avoid obscuring aspects of this disclosure.

Furthermore, a contractor or other entity may provide, or be hired to provide, the apparatus and/or method such as those disclosed in the present specification and shown in the figures. For instance, the contractor may receive a bid request for a project related to designing a system for feed conditioning automation or may offer to design such a method and accompanying system. The contractor may then provide the apparatus and/or method such as those discussed herein. The contractor may provide such a method by selling the apparatus and/or method or by offering to sell the apparatus and/or method, and/or the various accompanying parts and equipment to be used with and/or for said method. The contractor may provide a method and/or related equipment that are configured to meet the design criteria of a client or customer. The contractor may subcontract the fabrication, delivery, sale, or installation of a component of, or of any of the devices or of other devices contemplated for use with the method. The contractor may also maintain, modify or upgrade the provided devices and their use within the general method. The contractor may provide such maintenance or modifications by subcontracting such services or by directly providing those services.

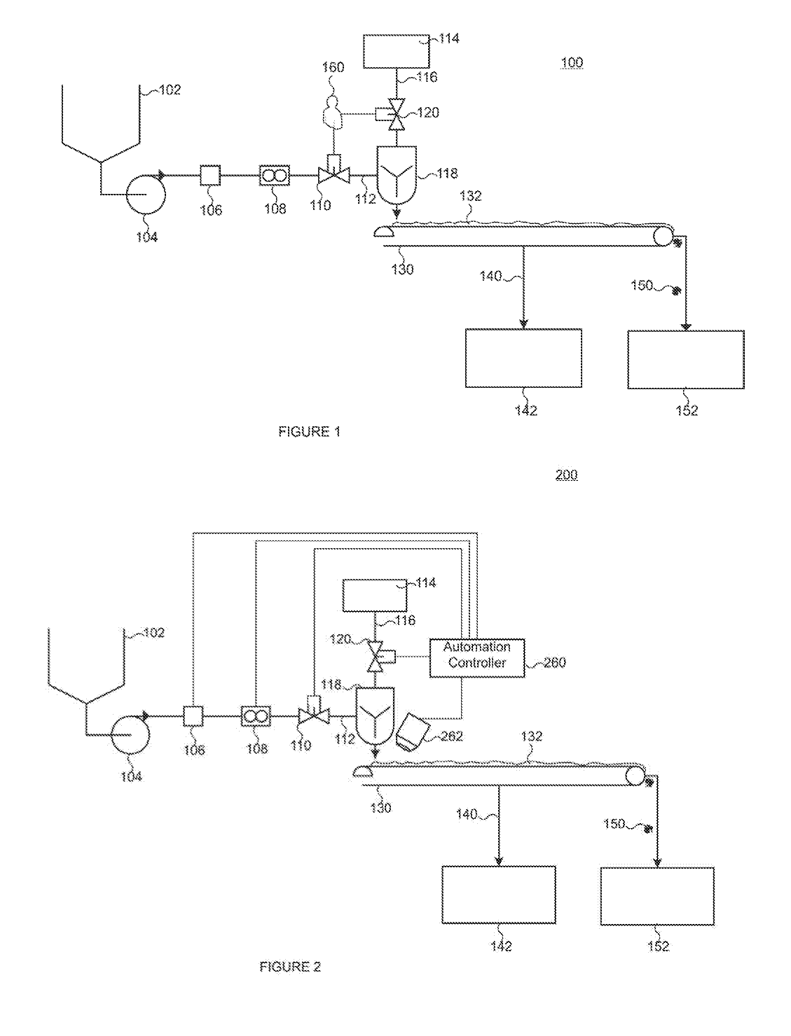

FIG. 1 illustrates one embodiment of a system for separating a slurry. Although various processes and systems may be described herein as systems for dewatering tailings, unless otherwise specifically indicated, the processes and systems herein may be applied to separating a slurry in general. The system 100 for separating a slurry as illustrated in FIG. 1 generally includes a thickener 102, a tank 114 or equivalent flocculant storage means, a mixing chamber 118, and a filter 130 for separating filtrate 140 from dry cake 150. As illustrated in FIG. 1, and as described in more detail herein, an operator 160 operates certain valves 110, 120 to control the flow rates of a feed slurry 112 and flocculant 116 to mixing chamber 118.

Thickener 102 receives a slurry from a process, where the slurry may include solid and liquid phases such as fine coal tailings and water. The slurry may further include flocculating agents to assist in a separation of the solid and liquid phases. Thickener 102 may be a thickener, paste thickener, settling tank, clarifier, stack clarifier, deep-cone paste thickener, superthickener, caisson thickener, traction thickener, sedimentation system, or the like. Thickener 102 may be configured to concentrate solids into a slurry 112 that includes a higher concentration of solids than in the influent slurry to the thickener 102. Slurry 112 may include from around 1% to around 50% solids; and more particularly from around 10% to around 40% solids; and even more particularly, around 30% solids, without limitation.

Slurry 112 may be removed from the thickener 102 using, for example, gravity or, as illustrated, pump 104. Slurry 112 may be transferred to a mixing chamber 118 from valve 110. Valve 110 may be a flow control valve 110 where a flow rate through the valve 110 may be controlled. As illustrated in FIG. 1, an operator 160 may control the valve 110. Further, the mixing chamber 118 may be any chamber capable of mixing the flocculant 116 and the slurry 112. Mixing chamber 118 may be converging pipes, agitated mixing chamber, a chamber with an impeller, a passive mixing chamber, a pipe, or the like.

Mixing chamber may also receive flocculant 116 from a flocculant tank 114. A pump (not separately illustrated) may be used in the transfer of the flocculant 116 to the mixing chamber 118. Valve 120, which may be a flow control valve 120, may be used to control a flow rate of the flocculant 116 to the mixing chamber 118. Flow of flocculant 116 to mixing chamber 118 may be controlled by an operator 160 using control valve 120.

Effluent from the mixing chamber may be in the form of a well-flocculated, “conditioned” feed 132 applied to a filter 130. Filter 130 may be any filter capable of removing a filtrate 140 from the filter cake 130, for example, a horizontal filter, a horizontal belt filter, a horizontal vacuum filter, a disc filter, a filter press, a twin-belt filter press, a pneumatic filter press, or the like. Filtrate 140 may be collected in filtrate collector 142. Dried filter cake 150 may be collected in filter cake collector 152. Water concentration in the conditioned feed 132 may be reduced to from around 1% to around 50% water, or more particularly from around 10% to around 55% water, or even to around 40% water, without limitation.

It should be noted that certain variations to the system illustrated in FIG. 1 may be used. For example, alternative mechanisms for transferring the slurry 112 to the filter 130 may be used, such as, for example, a variable speed pump that may be controlled by an operator 160 may be used in place of the control valve 110. Similarly, a variable speed pump that may be controlled by an operator 160 may be used in place of control valve 120 to control delivery of flocculant 116 to mixing chamber 118. In one embodiment, a flow of feed slurry 112 to the mixing chamber 118 is not controllable by the operator 160, but a flow of flocculant 116 to the mixing chamber 118 is controllable by the operator 160. In certain embodiments, the ratio of feed slurry 112 to flocculant 116 delivered to the mixing chamber 118 may be controllable using various mechanisms such as control valves, variable speed pumps, and so forth.

As mentioned above, a purpose of such a process is the efficient removal of water from the slurry. Another purpose is the reduction of the amount of flocculant used. Accordingly, the operator 160 may be trained to observe the filter cake 132 as it is placed on the filter 130, and adjust the flow of flocculant into the mixing chamber 118 accordingly. For example, the operator 160 may be positioned to observe the flocculated conditioned feed 132 as it is deposited on the filter 130. Judging from the condition of the flocculated conditioned feed 132, the operator 160 may increase or decrease the ratio of slurry 112 to flocculant 116 by modifying a flow rate of the flocculant using control valve 120, modifying a flow rate of the feed slurry 112 using control valve 110, or a combination of the two.

As mentioned above, a flocculant may be used to facilitate agglomeration of solids in the slurry 112 to form a well-flocculated conditioned feed slurry 132 for dewatering using a filter 130. A flocculant may be tailored to the specific feed slurry 112 used to optimize the conditioned feed 132 produced. For example, depending on the components of the feed slurry 112, a flocculant 116 may be selected to increase the effectiveness of the dewatering process. For example, tailings from a coal plant may be in the form of a slurry that contains fine coal particles, various types of clay, ash, miscellaneous minerals, and the like. Depending on such components, certain flocculants may be used. For example, anionic flocculants may be preferable for clay particles that include cationic edges. Cationic flocculants may be preferable for clay particles that include anionic edges. In some processes a nonionic flocculant may be preferable. In some applications multiple flocculants may be preferable. Flocculants may be used in various combinations and relative dosages in order to achieve the desired floc structure for the preconditioned slurry 132. Flocculants may be in the form of polymers.

Flocculant may function to agglomerate solid particles into clusters, facilitating dewatering of the conditioned feed 132 to the filter. Due to the cost of flocculant, it may be preferable to minimize the amount of flocculant used. Total cost of ownership for fine material dewatering processes using state-of-the art devices and methods may be extremely high, due to excessive flocculant consumption. Indeed, in some operations, the cost of the flocculant used on an annual basis may be in excess of the cost of the filter media used on a belt filter. Further, it is anticipated that in certain operations, the amount of flocculant used may be decreased by half, resulting in a savings approaching the cost of the filter media used. In some processes, where floc consumption is even more significant, the cost savings realized from reduced flocculant usage exhibited may even offset the cost of the entire filter in a short period of time. However, if too little flocculant is used, the slurry may not be well-flocculated or not be conditioned for efficient water removal and therefore, system performance is reduced, wear may increase, it may be more difficult to remove water from the paste, and a higher concentration of water in the dried filter cake 150 may be expected. Moreover, losses of solids to the filtrate 140 due to poor conditioning of feed slurry 132 to the filter 130 may cause filter media and other component damage. Thus, optimization of the amount of flocculant 116 used is preferred. The operator 160 may be trained to recognize the appearance of a well-conditioned flocculated feed 132 to the filter which is associated with an acceptable amount of flocculant used. In some cases, if too little flocculant is used, the flocculated conditioned feed 132 to the filter 130 may appear uniformly liquid and cloudy/translucent with insufficient or minimal visible agglomerated solids. If too much flocculant is used, the flocculated conditioned feed 132 to the filter 130 may appear to include excessively large clusters of solids in a transparent liquid and feel and slimy to the touch. When a correct amount of flocculant is used, the flocculated conditioned feed to the filter is not slimy and may appear as having optimal-sized clusters in a transparent liquid.

To further assist the operator 160 in determining a proper flow of flocculant 116 and/or slurry 112, the system of FIG. 1 illustrates a specific gravity sensor 106 for detecting a specific gravity of the paste and a flow meter 108 for measuring a flow rate of the slurry 112. The specific gravity and flow rate of the paste may be used by the operator 160 in determining an appropriate flow rate of the flocculant 116.

Although the embodiment described in FIG. 1 allows for an operator 160 to observe the conditioned feed 132 and manually control flocculant 116 applied thereto, there may be significant variability between operators, resulting in excess or insufficient flocculant 116 being used by certain operators. Furthermore, operators may tend to add excess flocculant in an effort to produce a dried filter cake 150 that appears to have a lower water concentration. Furthermore, there may be a range of ratios of slurry-to-flocculant that would yield an acceptably dry filter cake 150, but would not yield a noticeable difference in the conditioned flocculated feed 132 applied to the filter 130. Thus, there may be excess flocculant 116 used and unnoticed by the operator 160.

FIG. 2 illustrates another embodiment of a system 200 for dewatering slurry 112 from a thickener 102. According to this embodiment, addition of flocculant 116 to the mixing chamber 118 may be automated using an automation controller 260. Automation controller 260 may be any automation controller capable of receiving inputs, operating thereon, calculating a desired output, and applying a control signal in accordance with the calculated desired output. Automation controller 260 may be a computer-based automation controller with computer instructions operating on a processor, microprocessor, field programmable gate array (FPGA), application specific integrated circuit (ASIC), or the like. Automation controller 260 may include a number of inputs such as contact inputs, serial inputs, parallel inputs, or the like for receiving signals from input devices. Automation controller 260 may include a number of outputs such as contact outputs, serial outputs, parallel outputs, or the like for transmitting a signal according to the calculations made therein. Automation 260 controller may include a human-machine interface (HMI) or a port for connecting an HMI for operation thereof. Automation controller 260 may be programmable via the HMI or HMI port.

As is illustrated, automation controller 260 may receive signals from the specific gravity detector 106 and the flow meter 108. The system 200 may further include an optical detector 262 in optical communication with the filter cake 132 output from the mixing chamber 118. The optical detector 262 may be any capable of detecting an optical signal from the preconditioned feed 132 as it is deposited on the filter 130 from the mixing chamber 118 and transmit signals associated therewith to the automation controller 260. Optical detector 262 may be, for example, a visible light detector, an IR detector, an NIR detector, a laser rangefinder, a 3D imaging system, an X-ray detector, or the like, including combinations thereof. In one embodiment optical detector 262 includes a laser for projecting a laser line across the filter cake and cameras for observing the laser line, wherein the optical detector 262 or the automation controller 260 may use data from the cameras to calculate triangulation of the observed laser line.

Optical detector 262 may be configured to determine certain aspects of the filter cake 132 and transmit a signal according to such determinations to the automation controller 260. Alternatively, optical detector 262 may be configured to send observed data to the automation controller 260, which is itself configured to determine certain aspects of the preconditioned feed 132. In either embodiment, either the optical detector 262 or the automation controller 260, or both the optical detector 262 and the automation controller 260 may include computer instructions capable of determining an aspect of the preconditioned feed 132 from the observed data. In one embodiment, the computer instructions may include image recognition instructions. Image recognition instructions may include instructions for detecting properly flocculated slurry. That is, the image recognition instructions may be capable of determining cluster size, cluster spacing, cluster size populations, ratios of cluster size populations, cluster size distribution, cluster color, slurry and/or liquid color, depth of the filter cake, surface variability, and the like.

As mentioned, either the optical detector 262 or the automation controller 260 may include computer instructions for determining certain aspects of the preconditioned feed 132. Once the aspects of the preconditioned feed 132 are determined, the automation controller may apply a predetermined control method for adjusting a ratio of slurry 112 to flocculant 116. As with the operator, above, the ratio may be adjusted using control valve 120, control valve 110, variable speed pumps (not separately illustrated), or combinations thereof. Automation controller 260 may, for example, apply signals to such valves and/or pumps to increase or decrease flow of slurry and/or flocculant to the mixing chamber 118.

Further, the automation controller may use specific gravity as detected by the specific gravity detector 106 and/or the flow rate of the slurry 112 as detected by the flow rate meter 108 in a control scheme to control a ratio of slurry 112 to flocculant 116 using, for example, control valves 120 and/or 110.

### Example 1

### Control Using Image or Optical Attributes

In one specific embodiment, the optical detector 262 comprises a digital camera and a processor that includes computer instructions for image recognition and related algorithms that are capable of determining one or more of the following attributes: floc/agglomerate size (e.g., minimum or maximum diameter, profile boundary length, cross-sectional area, or approximated perimeter), image sharpness of floc profiles or boundaries of agglomerates within the flocculated conditioned feed 132 to the filter 130, color/tint/hue of liquid components, contrasts between the floc/agglomerate and liquid-solid interfaces (e.g., as determined by image recognition algorithms having predetermined intensity thresholds), and/or liquid clarity measurements (e.g., one or more values of translucency, such as % transparency from calibrated values). The optical detector 262 transmits a signal corresponding to one or more of the aforementioned attributes to the automation controller 260 once per second. The automation controller 260 receives the attribute data from the optical detector 262 to adjust the slurry-to-flocculant ratio. According to one example, automation controller may be configured to maintain one or more of the aforementioned attributes to be within a set of defined operating parameters. Values may be selected for the optimization of dewatering for a particular slurry 112 having its own unique characteristics. Values may also be selected for the optimization of dewatering to achieve desired cake 150 characteristics. Using such predetermined settings and observed attributes, the automation controller may control the flows of slurry and flocculant to the mixing chamber 118. The automation controller 260 may further adjust the flow of slurry, flocculant, or both depending on the detected one or more attributes as calculated using a signal from the optical detector and the predetermined settings for the one or more attributes. That is, from the signal from the optical detector, one or more of the abovementioned attributes are detected and compared with the predetermined settings. If one or more of the attributes indicate a poorly-defined floc or agglomerate profile, insufficient floc size, and/or cloudy homogenous appearance, then the automation controller may be configured to decrease the ratio of slurry to flocculant by adjusting the flow of slurry 112, flow of flocculant 116, or both. However, if one or more of the attributes indicate a well-defined, high contrast floc or agglomerate profile, oversized agglomerates, and/or clear liquid appearance, then the automation controller may be configured to increase the ratio of slurry to flocculant by adjusting the flow of slurry 112, flow of flocculant 116, or both. Such adjustment may be made incrementally in a loop feedback system so as to continually tune the system operating parameters for best efficiency and minimal flocculant usage.

### Example 2

### Control Using Specific Gravity and Flow Rate Attributes

In another specific embodiment, the automation controller 260 may be configured to apply a specific rate of dry tailings solids to the filter using the specific gravity detector 106 and the flow meter 108. In one alternative, a single meter is used to calculate both density and flow rate such as a nuclear density flowmeter. Using the density and flow rate, the automation controller may adjust the flow rate using, for example, valve 110 such that a predetermined flow rate of dry tailings solids are applied to the filter. To that end, in one example, from around 1 to around 100 dry tons of tailings solids per hour are applied to the mixing chamber; more particularly from around 10 to around 50 dry tons, and even more particularly, around 30 dry tons of dry tailings solids per hour are applied to the mixing chamber. Automation controller 260 may be configured to apply a specific rate of flocculant 116 to the mixing chamber 118 depending on the flow of slurry 112. That is, the automation controller may be configured to control a ratio of slurry to flocculant by controlling a rate of application of the flocculant to the mixing chamber. In one example, the automation controller may be configured to apply from around 0.01 to around 1.0 pounds of flocculant for each ton of dry tailing solids; more particularly from around 0.08 to around 0.5, and even more particularly, around 0.2 pounds of flocculant for each ton of dry tailings solids to the mixing chamber.

Automation controller 260 may be further configured to maintain one or more of the abovementioned image or optical attributes of the filter feed 132 within a range of optimized predetermined settings. Using the predetermined settings, specific gravity, and flow rates, the automation controller may control the flows of feed slurry 112 and flocculant 116 to the mixing chamber 118. The automation controller may further adjust the flow of slurry, flocculant, or both depending on the detected one or more attributes as calculated using a signal from the optical detector and the predetermined settings for said one or more attributes. That is, from the signal from the optical detector, one or more attributes are detected and compared with the predetermined settings. If the one or more detected attributes are within an optimum range, process conditions may remain unchanged. If the one or more detected attributes suggest a poorly-defined floc or agglomerate profile, insufficient floc size, and/or cloudy homogenous appearance, then the automation controller may be configured then the automation controller may be configured to decrease the ratio of slurry to flocculant by adjusting the flow of slurry, flow of flocculant, or both. However, if one or more of the attributes indicate a well-defined, high contrast floc or agglomerate profile, oversized agglomerates, and/or clear liquid appearance, then the automation controller 260 may be configured to increase the ratio of slurry to flocculant by adjusting the flow of slurry, flow of flocculant, or both.

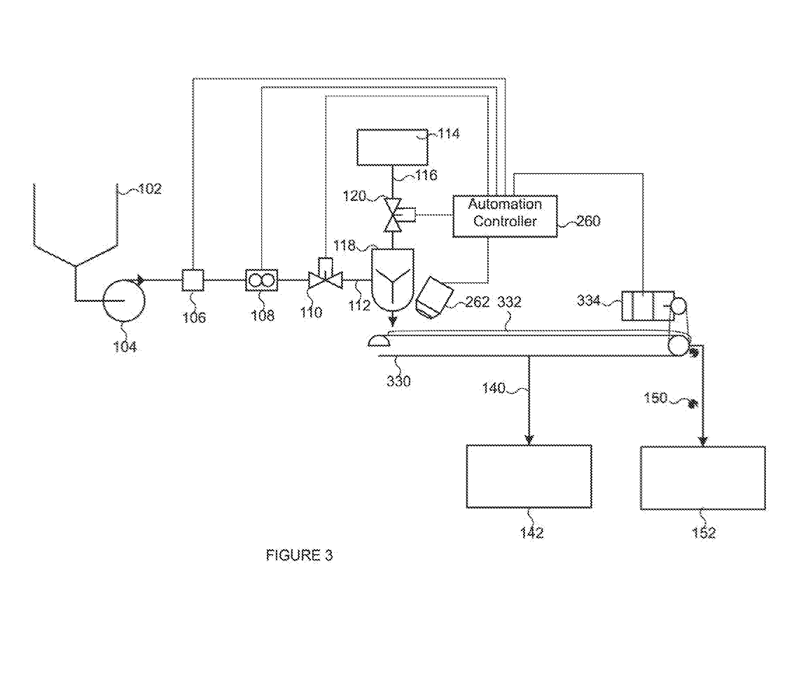

FIG. 3 illustrates yet another embodiment of a system 300 for dewatering slurry 112 from a thickener 102. Applying a uniform bed of preconditioned feed 132 to a filter 130 increases the efficiency of filtrate 140 removal from the filter cake 150. System 300 includes a belt filter 330 driven by a variable speed drive 332 that can control a speed of a belt of the filter 330. Controlling a speed of the belt of the filter 330 also controls a depth of the filter cake applied thereto from the mixing chamber 118. Thus, controlling a speed of the belt of the filter 330 could be used to control efficiency of filtrate 140 removal by controlling the depth and uniformity of the filter cake.

System 300 also includes an optical detector 262 and automation controller 260. Using optical observations from the optical detector 262, the system may be configured to determine a depth and/or uniformity of the preconditioned feed 332 as it is applied to the filter 330. The automation controller 260 may be configured to control a speed of the filter depending on a depth and/or uniformity of the feed 332 by adjusting a speed of the variable speed drive 334. In particular, automation controller 260 may output a signal corresponding to a desired speed, a signal corresponding with increasing speed, or with decreasing speed, or the like, to the variable speed drive 334 depending on the calculated depth or uniformity.

In one example, the optical detector may include computer instructions for calculating a depth of the distributed feed 332 and/or cake and transmitting the depth to the automation controller 260. The automation controller may be configured with a predetermined cake depth and predetermined upper and lower depth tolerances. If the determined filter cake depth exceeds an upper filter cake depth tolerance, the automation controller may be configured to signal the variable speed drive 334 to increase a speed of the belt of the filter 330, resulting in a decrease in filter cake depth. Conversely, if the determined filter cake depth falls below a lower filter cake depth tolerance, the automation controller may be configured to signal the variable speed drive 334 to decrease a speed of the belt of the filter 330, resulting in an increase in filter cake depth.

In another example, the optical detector may include computer instructions for calculating a change in depth of the filter cake and/or a rate of change in depth of the filter cake, and transmit such to the automation controller 260. Automation controller 260 may be configured to maintain a certain depth of the filter cake and predetermined upper and lower depth tolerances. Using the change in depth and/or the rate of change of depth, the automation controller may be configured to determine a change in depth of the filter cake, and whether the depth has exceeded or fallen below the upper and lower depth tolerances. If the determined filter cake depth exceeds an upper filter cake depth tolerance, the automation controller may be configured to signal the variable speed drive 334 to increase a speed of the belt of the filter 330, resulting in a decrease in filter cake depth. Conversely, if the determined filter cake depth falls below a lower filter cake depth tolerance, the automation controller may be configured to signal the variable speed drive 334 to decrease a speed of the belt of the filter 330, resulting in an increase in filter cake depth.

As is seen in FIG. 3, controlling the belt speed depending on the observed filter cake depth and/or uniformity may result in a filter cake that is more evenly distributed on the filter media.

The system 300 of FIG. 3 is configured to automate several aspects of the filter cake including flocculant addition and filter cake depth and/or uniformity. Such automation may be performed by an automation controller 260 that receives information about the system such as optical filter cake information, slurry density, slurry flow rate, and the like. Automation controller 260 may be capable of controlling certain aspects of the system using such inputs and calculations performed thereon such as, for example, slurry flow rate, flocculant flow rate, belt speed, and the like. Such control may result in optimized flocculant use and increased filter efficiency.

For example, in some non-limiting embodiments, belt drive speeds ranging between approximately 5 and 40 feet per minute, and filter cake thicknesses from approximately ¼ inch to ¾ inch may be anticipated.

### LISTING OF ENUMERATED ELEMENTS

100—System for dewatering tailings
102—Thickener
104—Pump
106—Specific gravity detector
108—Flow meter
110—Valve
112—Effluent from Valve 110
114—Flocculating agent tank
116—Effluent from Flocculating agent tank
118—Mixing chamber
120—Valve
130—Filter
132—Filter cake
140—Filtrate
142—Filtrate collection
150—Dry cake
152—Dry cake collection
160—Operator
200—System for dewatering tailings
260—Automation controller
262—Optical detector
300—System for dewatering tailings
330—Belt filter
332—Filter cake
334—Variable speed drive

What is claimed is:

1. A system for dewatering tailings, comprising:
a thickener;
a mixing chamber in communication with the thickener for receiving an effluent from the thickener and a flocculating agent tank;
a valve for selectively limiting a flow of flocculating agent from the flocculating agent tank to the mixing chamber;
a filter receiving effluent from the mixing chamber, the effluent being downstream of the mixing chamber, the filter comprising a belt;
an optical detector in optical communication with the effluent from the mixing chamber; the optical detector comprising a digital camera; and,
an automation controller in communication with the optical detector and the valve, the automation controller receiving the data from the optical detector, and providing a control signal to the valve based on the data from the optical detector; and,
wherein the automation controller or the optical detector comprises image recognition; wherein the image recognition is configured to determine contrast; and wherein the image recognition comprises an algorithm having a predetermined intensity threshold.

2. The system of claim 1, further comprising a specific gravity detector for detecting a specific gravity of the effluent from the thickener and communicating to the automation controller.

3. The system of claim 1, further comprising a flow meter for detecting a flow rate of the effluent from the thickener and communicating to the automation controller.

4. The system of claim 2, wherein the control signal to the valve is further based on the specific gravity of the effluent from the thickener.

5. The system of claim 3, wherein the control signal to the valve is further based on the flow rate of the effluent from the thickener.

6. The system of claim 1, further comprising:
a specific gravity detector for detecting a specific gravity of the effluent from the thickener and communicating with the automation controller;
a flow meter for detecting a flow rate of the effluent from the thickener and communicating to the automation controller;
wherein the control signal to the valve is further based on the specific gravity and flow rate of the effluent from the thickener.

7. The system of claim 1, wherein the filter comprises a motor with a variable frequency drive.

8. The system of claim 7, wherein the automation controller is in communication with the variable frequency drive, and provides a speed output to the variable frequency drive to control a speed of the filter.

9. The system of claim 8, wherein the speed output is based on the data from the optical detector.

10. The system of claim 9, wherein the speed output is based on a depth of a filter cake.

11. The system of claim 9, wherein the speed output comprises a command to increase or decrease a speed of the filter.

12. The system of claim 1, wherein the mixing chamber comprises one selected from the group consisting of: a mixing valve; a mixing tank; a header; and combinations thereof.

13. The system of claim 1, wherein the optical detector comprises a three-dimensional machine vision (3-DMV) sensor.

14. The system of claim 1, wherein the automation controller comprises 3-DMV software.

15. The system of claim 14, wherein the automation controller is configured to determine floc size and distribution, and the control signal to the valve is based on the floc size and distribution.

16. The system of claim 1, wherein the optical detector further comprises a laser rangefinder.

17. The system of claim 16, wherein a depth of a filter cake is determined using the laser rangefinder.

18. The system of claim 17, wherein a floc size and distribution is determined using the laser rangefinder.

19. The system of claim 1, wherein the optical detector further comprises an infrared (IR) spectrometer.

20. The system of claim 1, wherein the optical detector comprises an image detector.

21. The system of claim 1, wherein said image recognition is configured to determine floc size and distribution.

22. The system of claim 1, wherein the image recognition is further configured to determine color.

23. The system of claim 1, wherein the image recognition is further configured to determine a depth of a filter cake.
